(19) United States
(12) Patent Application Publication
(10) Pub. No.: US 2025/0155564 A1
(43) Pub. Date: May 15, 2025

(54) ERROR CORRECTION METHOD FOR ACTIVE ELECTRONICALLY SCANNED ARRAY RADAR SYSTEM

(71) Applicant: AGENCY FOR DEFENSE DEVELOPMENT, Daejeon (KR)

(72) Inventors: Hyuksoo SHIN, Daejeon (KR); Jeonghun HWANG, Daejeon (KR); Yongjun HONG, Daejeon (KR); Byunglae CHO, Daejeon (KR)

(73) Assignee: AGENCY FOR DEFENSE DEVELOPMENT, Daejeon (KR)

(21) Appl. No.: 18/914,245

(22) Filed: Oct. 13, 2024

(30) Foreign Application Priority Data
Nov. 13, 2023 (KR) 10-2023-0156311

(51) Int. Cl. G01S 13/42; G01S 7/40

(52) U.S. Cl. CPC G01S 13/426; G01S 7/4008; G01S 7/403

(57) ABSTRACT

An error correction method for an active electronically scanned array (AESA) radar system including a user interface, a processor, and a memory includes receiving, by the user interface, a user input for a target steering angle, determining, by the processor, a first input angle according to the user input, extracting, by the processor, a first measured angle corresponding to the first input angle from a radome angle table stored in the memory, calculating, by the processor, a first error by comparing the target steering angle with the first measured angle, comparing, by the processor, the first error with a predetermined threshold value, determining, by the processor, the first input angle as a correction angle when the first error is less than the predetermined threshold value, and generating, by the processor, for an AESA radar, a beam steering command including the correction angle.

### CROSS-REFERENCE TO RELATED APPLICATION

This application is based on and claims priority under 35 U.S.C. § 119 to Korean Patent Application No. 10-2023-0156311, filed on Nov. 13, 2023, in the Korean Intellectual Property Office, the disclosure of which is incorporated by reference herein in its entirety.

### BACKGROUND

### 1. Field

The disclosure relates to a method of correcting an error of an input angle of an active electronically scanned array (AESA) radar system by using a table in which a target angle and a measured angle of a beam refracted by a radome that are matched to each other are stored in advance.

### 2. Description of the Related Art

A radome is mounted on a front portion of an antenna to physically protect a radar, and a beam transmitted or received by the radar may be refracted or offset according to a form or material of the radome. Beam refraction referred to as a radome bore sight error causes a difference between an angle at which the beam is actually reflected and an angle of the beam received by the antenna, which degrades the target estimation performance of the radar.

There are roughly two methods for addressing the performance degradation due to the radome bore sight error.

The first method is a filter designing method based on a radome model used for a guided weapon system or a tracking radar, wherein a radome refraction error model is set based on a radome shape model and a filter is designed by using bore sight information obtained during a tracking time from an explorer or a radar, thereby estimating and compensating for the radome refraction error.

This method is difficult to apply when the radar does not perform tracking, and with this method, it may be difficult to remove a modeling error when the accuracy of the radome shape model is not guaranteed.

In the second method, the radome bore sight error is measured, the measured value is stored in a database, and the measured value is corrected in real time in a layer operation in which measurement points are selected in a radar beam radiation region of interest, a target is installed in one measurement point, and a difference in a measurement result is calculated at the time of removal of the radome to measure a degree of distortion of received electric waves. This process is repeated for all the measurement points to configure and store the database, and a gimbal driving angle of the radar is rotated in the opposite direction based on the database, thereby correcting the radome bore sight error.

Although this method needs a facility for measurement, such as three-dimensional (3D) measurement equipment, etc., it may guarantee the stablest performance when measurement is possible.

An active electronically scanned array (AESA) radar does not use mechanical gimbal driving, thus requiring a new scheme using a radome error correction method based on a measurement value.

First, a method may be considered in which a result of signal processing at a reception side of an AESA radar system is corrected. In this method, measurement data is interpolated, and a separate data conversion technique is required, but the amount of computation of a signal processing board that performs a compensation operation increases inevitably.

Moreover, a beam pointing error due to the radome bore sight error is avoidable in transmission, and a deviation in signal processing results before and after radome refraction due to the beam pointing error may not be solved merely by performing radome error correction at the reception side.

Also, a method may be considered in which a radar bore sight error is corrected in beam transmission. For the AESA radar, a method may be taken into account in which an electronic steering angle is corrected such that a beam transmission angle becomes a target steering angle after radome refraction, and a command is transmitted to an antenna. This method may reduce a computational load of the signal processing board, and the accuracy may be improved in multiple target angle estimation using multiple beams, which may be an advantage of the AESA radar.

Consequently, a method for calculating an input angle for transmission at a specific angle after radome refraction in reverse from a measurement database may be additionally required.

Therefore, there is a need for a method of estimating an input angle for transmitting a beam at a target angle after radome refraction by using an iterative method based on a measured value of a radome bore sight error.

### SUMMARY

Provided is a method of correcting an error of an input angle of an active electronically scanned array (AESA) system by iteratively using a table in which a target angle and a measured angle of a beam refracted by a radome that are matched to each other are stored in advance.

Additional aspects will be set forth in part in the description which follows and, in part, will be apparent from the description, or may be learned by practice of the presented embodiments of the disclosure.

According to an aspect of the disclosure, an error correction method for an active electronically scanned array (AESA) radar system including a user interface, a processor, and a memory includes receiving, by the user interface, a user input for a target steering angle, determining, by the processor, a first input angle according to the user input, extracting, by the processor, a first measured angle corresponding to the first input angle from a radome angle table stored in the memory, calculating, by the processor, a first error by comparing the target steering angle with the first measured angle, comparing, by the processor, the first error with a predetermined threshold value, determining, by the processor, the first input angle as a correction angle when the first error is less than the predetermined threshold value, and generating, by the processor for an AESA radar, a beam steering command including the correction angle.

According to an example, the error correction method may further include determining, by the processor, an angle obtained by reducing the first input angle by the first error as a second input angle, when the first error is greater than or equal to the predetermined threshold value, in which the processor is configured to iteratively the extracting of the measured angle for the second input angle, the calculating of the error, and the comparing of the error with the predetermined threshold value.

According to another example, the error correction method may further include determining, by the processor, an immediately previous input angle as the correction angle at a point in time when a number of iteratively performing times is greater than or equal to a predetermined number of times.

According to another example, the radome angle table may be a table in which an angle of a beam not passing through the radome and an angle of a beam refracted after passing through the radome are matched to each other, and the first input angle may correspond to the angle of the beam not passing through the radome, and the first measured angle may correspond to the angle of the beam refracted while passing through the radome.

According to another example, the radome angle table may be a table regarding at least one of an azimuth angle and an elevation angle of a beam.

According to another example, the extracting of the first measured angle corresponding to the first input angle from the radome angle table may be performed when there is the first measured angle corresponding to the first input angle in the radome angle table, and the error correction method may further include, when there is not the first measured angle corresponding to the first input angle in the radome angle table, extracting, by the processor, an input angle closest to the first input angle from the radome angle table, extracting, by the processor, a measured angle corresponding to the closest input angle from the radome angle table, and determining, by the processor, the first measured angle based on the closest measured angle.

According to another example, the closest input angle may include an upper input angle and a lower input angle that is closest to the first input angle, the closest measured angle may include an upper measured angle corresponding to the upper input angle and a lower measured angle corresponding to the lower input angle, and the first measured angle may be an angle obtained by interpolating the first input angle, the upper input angle, the lower input angle, the upper measured angle, and the lower measured angle.

According to another example, the input angle, the measured angle, and the correction angle may include at least one of an azimuth angle and an elevation angle of a beam.

According to another example, the processor may be configured to perform the receiving of the user input through the determining of the correction angle for each of a plurality of frequencies.

According to another example, the processor may be further configured to determine, as the correction angle, a sum of a plurality of correction angles respectively determined for the plurality of frequencies.

According to another example, the first error may be calculated from an absolute value of a difference between the first input angle and the first measured angle.

According to another aspect of the disclosure, a computer-readable recording medium has recorded thereon a program for executing the above-described error correction method for the AESA radar system on a computing device.

According to another aspect of the disclosure, a computer program is stored in a medium to execute the above-described error correction method for the AESA radar system on a computing device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a computing device for correcting an error of an input angle of an active electronically scanned array (AESA) radar system by using a table in which a target angle and a measured angle of a beam refracted by a radome that are matched to each other are stored in advance, according to an embodiment;

FIG. 2 is shows a concept of determining a compensation angle for an input angle of an AESA radar system, based on a target angle and a measured angle of a beam refracted by a radome, according to an embodiment;

FIG. 3 is a flowchart of a method of correcting an error of an input angle of an AESA radar system by using a table in which a target angle and a measured angle of a beam refracted by a radome that are matched to each other are stored in advance, according to an embodiment;

FIG. 4 is a flowchart of a method of extracting a measured angle based on whether a measured angle corresponding to an input angle in a radome angle exists in a table, according to an embodiment; and

FIG. 5 is a graph showing the effect of a method of correcting an error of an input angle of an AESA radar system by using a table in which a target angle and a measured angle of a beam refracted by a radome that are matched to each other are stored in advance, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, various embodiments will be described in detail with reference to the attached drawings to allow those of ordinary skill in the art to easily carry out the technical spirit of the disclosure. However, the technical spirit of the disclosure may not be limited to the embodiments described herein because it may be transformed into various forms and implemented. In the description of the examples disclosed herein, the detailed description of the related known technology will be omitted if it is determined to obscure the subject matter of the technical spirit of the disclosure. Identical or similar components will be given identical reference numerals and will not be repeatedly described.

The terms used herein are solely for describing specific embodiments, and are not intended to limit the disclosure to the dictionary meaning of the terms. Throughout the specification, when a component is “connected” to another component, it may include not only a case where they are “directly connected”, but also a case where they are “indirectly connected” with another component therebetween. When a component is referred to as “includes” another component, it may mean that the component may further include still another component rather than excluding the still another component unless stated otherwise.

Hereinbelow, an embodiment will be described in detail with reference to the accompanying drawings.

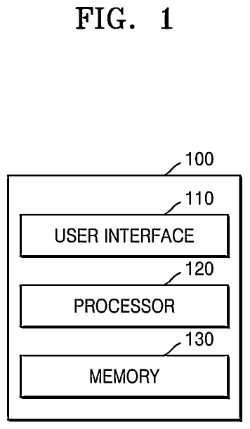

FIG. 1 is a block diagram of a computing device for correcting an error of an input angle of an active electronically scanned array (AESA) radar system by using a table in which a target angle and a measured angle of a beam refracted by a radome that are matched to each other are stored in advance, according to an embodiment.

Referring to FIG. 1, a computing device 100 may include a user interface 110, a processor 120, and a memory 130.

The user interface 110 may receive a user input.

The user interface 110 may directly receive the user input through a screen or the like. For example, the user interface 110 may receive a user input to select an input angle.

The user interface 110 may also receive the user input from an external device and transmit the same to the processor 120. For example, the user interface 110 may be connected to a network to communicate with an external device and to receive a user input to select an input angle from a user terminal that is an external device.

The processor 120 may control an overall operation of the computing device 100. The processor 120 may be configured to perform basic arithmetic, logic, and input/output operations and process a command of a program. The processor 120 may control the user interface 110 and the memory 130.

The processor 120 may determine an input angle of a beam of the AESA radar system according to a user input, extract a measured angle corresponding to the input angle from a radome angle table stored in the memory 130, compare the target angle with the measured angle to calculate an error, compare the error with a predetermined threshold value, and determine the input angle as a correction angle when the error is less than the threshold value, and generate a steering command of the AESA radar system, which includes the determined correction angle.

The processor 120 may redetermine an angle reduced by the error from the input angle as an input angle when the error is greater than or equal to the threshold value, and iteratively perform measured angle extraction, error calculation, and comparison between the error and the threshold value, for the redetermined input angle.

In this way, it may be possible to effectively correct an error of an input angle of an AESA radar system by using a table in which a target angle and a measured angle of a beam refracted by a radome are matched to each other and are stored in advance.

In this case, the processor 120 may determine an immediately previous input angle as a correction angle at a point in time when the number of iteratively performing times is greater than or equal to a predetermined number even though the error is not less than the threshold value.

As such, by limiting the number of times of resetting the input angle, an unnecessary time required for error correction of the AESA radar system may be saved.

The memory 130 may be a recording medium readably by the computing device 100 and include a permanent mass storage device such as random access memory (RAM), read only memory (ROM), and a disk drive. Various data used for the computing device 100, e.g., a program and input and output data of a command related thereto may be stored in the memory 130.

A radome angle table may be stored in the memory 130.

The radome angle table may be a lookup table in which an angle of a beam not passing through the radome and an angle of a beam refracted while passing through the radome are matched to each other, but the disclosure is not limited thereto.

Meanwhile, the radome angle table may be a table regarding at least one of an azimuth angle and an elevation angle, but the disclosure is not limited thereto.

Herein, the input angle determined by the processor 110 may correspond to an angle of a beam not passing through a radome in the radome angle table stored in the memory 130, and the measured angle extracted by the processor 110 may correspond to an angle of a beam refracted while passing through the radome in the radome angle table stored in the memory 130.

That is, the processor 110 may extract the angle of the beam not passing through the radome, which corresponds to the input angle, from the radome angle table, extract the angle of the beam refracted while passing through the radome, which corresponds to the angle of the beam not passing through the radome, and determine the extracted angle of the beam refracted while passing through the radome, as the measured angle, but the disclosure is not limited thereto.

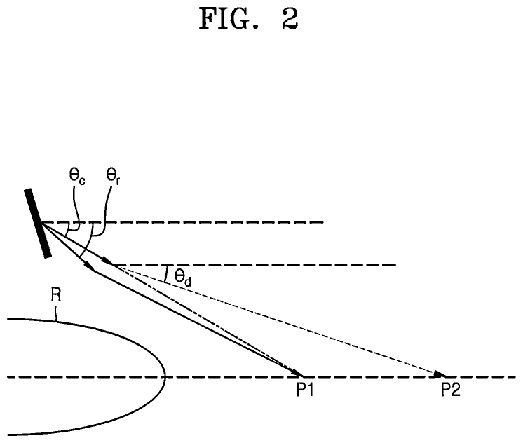

FIG. 2 shows a concept of determining a compensation angle for an input angle of an AESA radar system, based on a target angle and a measured angle of a beam refracted by a radome, according to an embodiment.

Referring to FIG. 2, when a target steering point is a first steering point P1, the AESA radar system may set a target steering angle θ_{c} as an angle corresponding to the first steering point P1, and when the radar steers the beam based on the target steering angle θ_{c}, the beam may be refracted while passing through a radome R and steered at an angle θ_{d} after refraction, such that the beam may be transmitted to a second steering point P2 that is different from the first steering point P1.

Thus, to transmit the beam to the first steering point P1, the AESA radar system may set the correction steering angle, corresponding to the first steering point P1. In this case, when the radar steers the beam based on the correction steering angle θᵣ, the beam may be refracted while passing through the radome R and thus steered at the target steering angle θ_{c}, such that the beam may be transmitted to the first steering point P1.

The radome angle table according to an embodiment may be a table in which the target steering angle θ_{c}, and an angle after refraction, θ_{c}, may be matched to each other and be stored. Hereinbelow, a method of correcting an error in beam transmission by using a radome angle table stored in a database will be described in more detail.

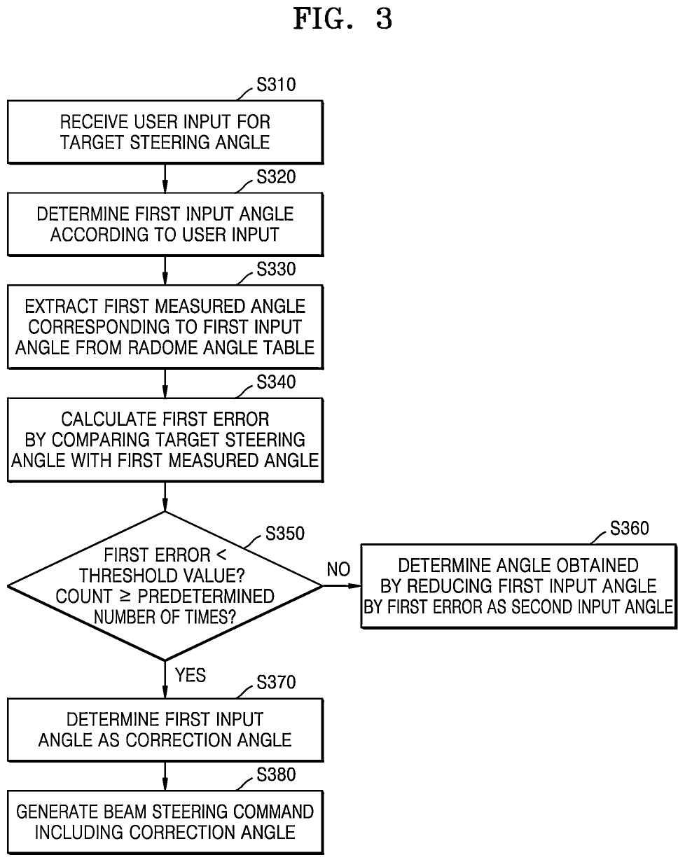

FIG. 3 is a flowchart of a method of correcting an error of an input angle of an AESA radar system by using a table in which a target angle and a measured angle of a beam refracted by a radome that are matched to each other are stored in advance, according to an embodiment.

Referring to FIG. 3, when the user interface 110 receives a user input for a target steering angle in operation S310, the processor 120 may determine a first input angle according to the user input in operation S320.

The target steering angle φ_{ε}, θ_{ε} may include a target steering azimuth angle φ_{ζ} and a target steering elevation angle θ_{ζ}.

The first input angle may mean an input angle set according to the user input.

The first input angle may be, for example, the target steering angle φ_{ε}, θ_{ε}.

During operation S320, the processor 120 may start counting the number of iteratively performing times.

Equation 1 shows the initial input angle and the number of iteratively performing times.

$$\begin{matrix}{φ}_{input} ( k ) = φ \text{?} k = 1 \\ {θ}_{input} ( k ) = θ \text{?} k = 1 \\ count = 1\end{matrix} \qquad [ Equation 1 ]$$

$$\text{?} \text{indicates text missing or illegible when filed}$$

In Equation 1, φ_{c} indicates a target steering azimuth angle, φᵢₙₚᵤₜ(k) indicates a k-th input azimuth angle, θ_{c} indicates a target steering elevation angle, θᵢₙₚᵤₜ(k) indicates a k-th input elevation angle, and count indicates the number of iteratively performing times.

Next, the processor 120 may extract, from the radome angle table stored in the memory 130, a first measured angle corresponding to the first input angle, in operation S330.

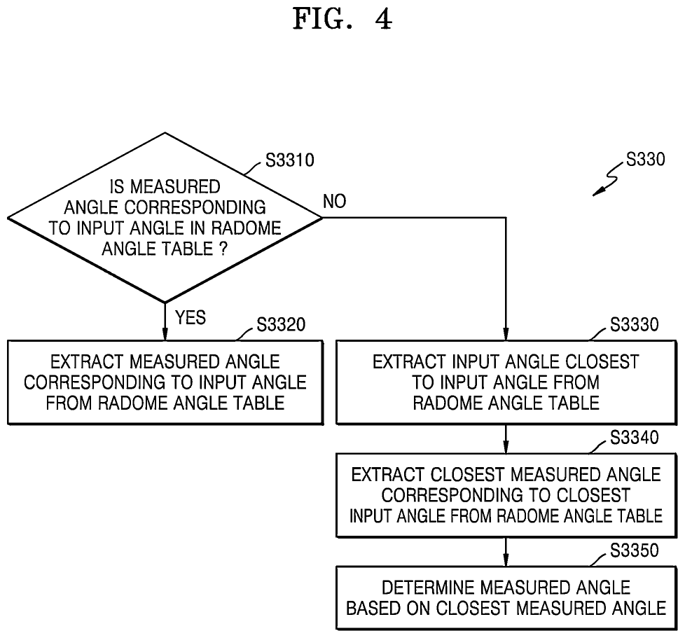

Hereinbelow, operation S330 will be described in more detail with reference to FIG. 4.

FIG. 4 is a flowchart of a method of extracting a measured angle based on whether a measured angle corresponding to an input angle exists in a radome angle table, according to an embodiment.

Referring to FIG. 4, the processor 120 may determine whether a measured angle corresponding to an input angle is in a radome angle table, in operation S3310.

The radome angle table may be a table in which an angle of a beam not passing through the radome and an angle of a beam refracted after passing through the radome are matched to each other.

The input angle may correspond to an angle of the beam not passing through the radome in the radome angle table, and the measured angle may correspond to an angle of the beam refracted while passing through the radome.

For example, the processor 120 may determine whether the same angle as the input angle is in an angle list of the beam not passing through the radome in the radome angle table.

When there is a measured angle corresponding to the input angle in the radome angle table, the processor 120 may extract the measured angle corresponding to the input angle from the radome angle table, in operation S3320.

For example, the processor 120 may extract the angle of the beam refracted while passing through the radome, which is matched to the angle of the beam not passing through the radome, as the measured angle, when there is the same angle as the input angle in the angle list of the beam not passing through the radome in the radome angle table.

When there is not a measured angle corresponding to the input angle in the radome angle table, the processor 120 may extract the input angle closest to the input angle from the radome angle table, in operation S3330.

For example, when there is not the same angle as the input angle in the angle list of the beam not passing through the radome in the radome angle table, the processor 120 may extract an upper input angle and a lower input angle that are closest to the input angle.

The processor 120 may extract the input angles φᵢₙₚᵤₜ(k), θᵢₙₚᵤₜ(k), the closest upper input angles φᵤₚₚₑᵣ, θᵤₚₚₑᵣ, and lower input angles φ_{lower}, θ_{lower}.

$$\begin{matrix}{φ}_{upper} = ceil ( {φ}_{input} ( k ) / Δφ ) \times Δφ \\ {φ}_{lower} = floor ( {φ}_{input} ( k ) / Δφ ) \times Δφ \\ {θ}_{upper} = ceil ( {θ}_{input} ( k ) / Δθ ) \times Δθ \\ {θ}_{lower} = floor ( {θ}_{input} ( k ) / Δθ ) \times Δθ\end{matrix} \qquad [ Equation 2 ]$$

In Equation 2, φᵤₚₚₑᵣ indicates an upper input azimuth angle, φ_{lower} indicates a lower input azimuth angle, Δφ indicates an interval between azimuth angles included in the radome angle table, θᵤₚₚₑᵣ indicates an upper input elevation angle, θ_{lower} indicates a lower input elevation angle, and Δθ indicates an interval between elevation angles included in the radome angle table.

Next, the processor 120 may extract, from the radome angle table, the closest measured angle corresponding to the closest input angle in operation S3340.

For example, the processor 120 may extract, from the radome angle table, the upper measured angles f(φᵤₚₚₑᵣ, θᵤₚₚₑᵣ,f(l)) and lower measured angles f(φ_{lower}, θ_{lower}, f(l)), g(φ_{lower},θ_{lower},f(l)) corresponding to the upper input angles φᵤₚₚₑᵣ, θᵤₚₚₑᵣ and the lower input angles φ_{lower},θ_{lower}.

Next, the processor 120 may determine a measured angle based on the closest measured angle.

For example, the processor 120 may calculate the measured angle by interpolating the input angles φᵢₙₚᵤₜ(k), θᵢₙₚᵤₜ(k), the upper input angles φᵤₚₚₑᵣ, θᵤₚₚₑᵣ, the lower input angles φ_{lower}, θ_{lower}, the upper measured angles f(φᵤₚₚₑᵣ,θᵤₚₚₑᵣ,f(l)), g(φᵤₚₚₑᵣ,θᵤₚₚₑᵣ,f(l)), and the lower measured angles f(θ_{lower},θ_{lower},f(l)), g(φ_{lower},θ_{lower},f(l)).

The processor 120 may perform linear interpolation by using Equation 3.

$$\begin{matrix}φ \text{?} ( k ) = \frac{φ \text{?} ( k ) - φ \text{?}}{φ \text{?} - φ \text{?}} f ( φ \text{?} , θ \text{?} , f ( \text{?} ) ) + \frac{φ \text{?} - φ \text{?} ( k )}{φ \text{?} - φ \text{?}} f ( φ \text{?} , θ \text{?} , f ( \text{?} ) ) \\ θ \text{?} ( k ) = \frac{θ \text{?} ( k ) - θ \text{?}}{θ \text{?} - θ \text{?}} g ( φ \text{?} , θ \text{?} , f ( \text{?} ) ) + \frac{θ \text{?} - θ \text{?} ( k )}{θ \text{?} - θ \text{?}} g ( φ \text{?} , θ \text{?} , f ( \text{?} ) )\end{matrix} \qquad [ Equation 3 ]$$

$$\text{?} \text{indicates text missing or illegible when filed}$$

In Equation 3, φ_{d}(k) indicates a measured azimuth angle, f(φᵤₚₚₑᵣ,θᵤₚₚₑᵣ,f(l)) indicates a measured azimuth angle having an azimuth angle of φᵤₚₚₑᵣ, an elevation angle of θᵤₚₚₑᵣ, and a frequency of l, f(φ_{lower},θ_{lower},f(l)) indicates a measured azimuth angle having an azimuth angle of φ_{lower}, an elevation angle of θ_{lower}, and a frequency of l,θ_{d}(k) indicates a measured elevation angle, g(φᵤₚₚₑᵣ,θᵤₚₚₑᵣ,f(l)) indicates a measured elevation angle having an azimuth angle of φᵤₚₚₑᵣ, an elevation angle of θᵤₚₚₑᵣ, and a frequency of i, and g(φ_{lower},θ_{lower},f(l)) indicates a measured elevation angle having an azimuth angle of φ_{lower}, an elevation angle of θ_{lower}, and a frequency of l.

As such, according to an embodiment, by additionally performing interpolation, a correction angle may be calculated for an angle not stored in the radome angle table, thereby achieving error correction without a gap.

Referring back to FIG. 3, the processor 120 may calculate a first error by comparing a target steering angle with a first measured angle, in operation S340.

For example, the processor 120 may obtain first errors ϵ_{az}(k), ϵₑₗ (k) from differences between the target steering angles ϕ_{c}, θ_{c} and the first measured angles ϕ_{d}(k), θ_{d}(k), by using Equation 4.

$$\begin{matrix}ϵ \text{?} ( k ) = φ \text{?} ( k ) - φ \text{?} \\ ϵ \text{?} ( k ) = θ \text{?} ( k ) - θ \text{?}\end{matrix} \qquad [ Equation 4 ]$$

$$\text{?} \text{indicates text missing or illegible when filed}$$

In Equation 4, ϵ_{az}(k) indicates an azimuth angle error, and ϵₑₗ(k) indicates an elevation angle error.

Next, the processor 120 may compare the first error with the predetermined threshold value in operation S350, and determine the first input angle as the correction angle when the first error is less than the predetermined threshold value or a count is greater than or equal to a predetermined number of times, in operation S370.

Operation S350 is an operation of determining whether Equation 5 is satisfied.

$$( ϵ \text{?} \text{?} \text{?} and ϵ \text{?} \text{?} \text{?} ) or count \text{?} \text{?} \qquad [ Equation 5 ]$$

$$\text{?} \text{indicates text missing or illegible when filed}$$

In Equation 5, ϵ indicates the predetermined threshold value, and N indicates the predetermined number of times.

The threshold value ϵ to be compared with the azimuth angle error ϵ_{az}(k) and the threshold value ϵ to be compared with the elevation angle error ϵₑₗ(k) may be equal to or different from each other.

When the first error is greater than or equal to the predetermined threshold value or the count is less than the predetermined number of times, the processor 120 may determine, as a second input angle, an angle obtained by reducing the first input angle by the first error in operation S360.

The processor 120 may calculate the second input angle by using Equation 6.

$$\begin{matrix}{φ}_{input} ( k + 1 ) = {φ}_{input} \text{?} ( k ) - ϵ \text{?} ( k ) \\ {θ}_{input} ( k + 1 ) = {θ}_{input} ( k ) - ϵ \text{?} ( k ) \\ count = count + 1\end{matrix} \qquad [ Equation 6 ]$$

$$\text{?} \text{indicates text missing or illegible when filed}$$

ϕᵢₙₚᵤₜ(k) indicates a k-th input azimuth angle, ϕᵢₙₚᵤₜ(k+1) indicates a k+1-th input azimuth angle, θᵢₙₚᵤₜ(k) indicates a k-th input elevation angle, and θᵢₙₚᵤₜ(k+1) indicates a k+1-th input elevation angle.

Next, the processor 120 may perform operations S330, S340, and S350 with respect to the second input angle.

As such, until an error according to an input angle satisfies a condition of Equation 5, i.e., until the error is less than a threshold value or a count is greater than or equal to a predetermined number of times, operations S330, S340, and S350 may be iteratively performed.

When the k′-th input angle satisfies the condition of Equation 5, the processor 120 may determine the correction angle by using Equation 7.

$$\begin{matrix}φ \text{?} ( l ) = {φ}_{input} ( {k}^{′} ) \\ θ \text{?} ( l ) = {θ}_{input} ( {k}^{′} )\end{matrix} \qquad [ Equation 7 ]$$

$$\text{?} \text{indicates text missing or illegible when filed}$$

ϕᵣ(l) indicates a correction azimuth angle having a frequency of l, θᵣ(l) indicates a correction elevation angle having a frequency of l, ϕᵢₙₚᵤₜ(k′) indicates a k′-th input azimuth angle, and θᵢₙₚᵤₜ(k′) indicates a k′-th input elevation angle.

Next, the processor 120 may generate a beam steering command, which includes the determined correction angle, for an AESA radar, in operation S380.

The processor 120 may perform operations S310 to S370 with respect to a plurality of frequencies. In this case, the processor 120 may determine, as the correction angle, a sum of a plurality of correction angles respectively determined for a plurality of frequencies.

The processor 120 may determine a final correction angle for the plurality of frequencies, by using Equation 8.

$$\begin{matrix}\overline{φ} \text{?} = \frac{1}{L} {\sum }_{l = 1}^{L} φ \text{?} ( l ) \\ \overline{θ} \text{?} = \frac{1}{L} {\sum }_{l = 1}^{L} θ \text{?} ( l )\end{matrix} \qquad [ Equation 8 ]$$

$$\text{?} \text{indicates text missing or illegible when filed}$$

In Equation 8, ϕ̅ᵣ̅ indicates a final correction azimuth angle, θ̅ᵣ̅ indicates a final correction elevation angle, and L indicates the number of frequencies.

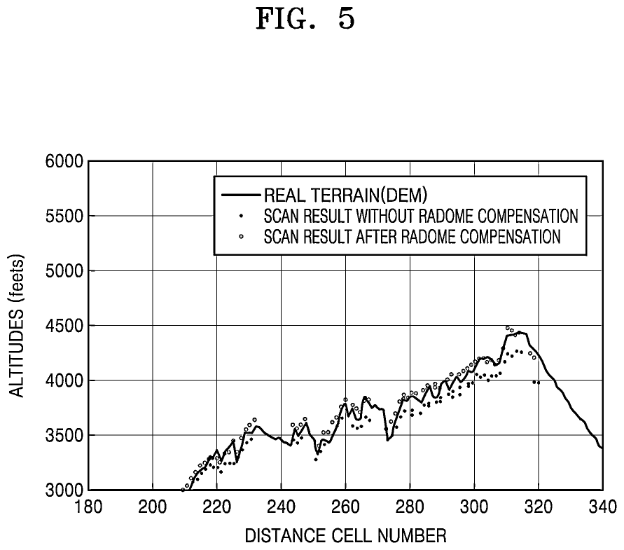

FIG. 5 is a graph showing the effect of a method of correcting an error of an input angle of an AESA radar system by using a table in which a target angle and a measured angle of a beam refracted by a radome are matched to each other and are stored in advance, according to an embodiment.

Referring to FIG. 5, with an error correction method for an AESA radar system according to an embodiment, it may be seen that a terrain estimation result after radome correction is closer to DEM information corresponding to real terrain than a terrain estimation result before radome correction, that is, it may be seen that estimation performance of a radar is improved.

The various embodiments described herein are illustrative and are not to be independently implemented separately from each other. Embodiments described herein may be implemented in combination with each other.

The scope of the disclosure is defined by the following claims rather than the detailed description, and the meanings and scope of the claims and all changes or modified forms derived from their equivalents should be construed as falling within the scope of the disclosure.

According to the disclosure, it may be possible to effectively correct an error of an input angle of an AESA radar system by iteratively using a table in which a target angle and a measured angle of a beam refracted by a radome that are matched to each other are stored in advance.

As such, by limiting the number or iterative times, an unnecessary time required for error correction of the AESA radar system may be saved.

Moreover, by additionally performing interpolation, a correction angle may be calculated for an angle not stored in the radome angle table, thereby achieving error correction without a gap.

As a result, an estimation result closer to a real shape may be generated.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An error correction method for an active electronically scanned array (AESA) radar system comprising a user interface, a processor, and a memory, the error correction method comprising:
receiving, by the user interface, a user input for a target steering angle;
determining, by the processor, a first input angle according to the user input;
extracting, by the processor, a first measured angle corresponding to the first input angle from a radome angle table stored in the memory;
calculating, by the processor, a first error by comparing the target steering angle with the first measured angle;
comparing, by the processor, the first error with a predetermined threshold value;
determining, by the processor, the first input angle as a correction angle when the first error is less than the predetermined threshold value; and
generating, by the processor for an AESA radar, a beam steering command comprising the correction angle.

2. The error correction method of claim 1, further comprising determining, by the processor, an angle obtained by reducing the first input angle by the first error as a second input angle, when the first error is greater than or equal to the predetermined threshold value,
wherein the processor is configured to iteratively perform the extracting of the measured angle for the second input angle, the calculating of the error, and the comparing of the error with the predetermined threshold value.

3. The error correction method of claim 2, further comprising determining, by the processor, an immediately previous input angle as the correction angle at a point in time when a number of iteratively performing times is greater than or equal to a predetermined number of times.

4. The error correction method of claim 1, wherein the radome angle table is a table in which an angle of a beam not passing through the radome and an angle of a beam refracted after passing through the radome are matched to each other, and
the first input angle corresponds to the angle of the beam not passing through the radome, and the first measured angle corresponds to the angle of the beam refracted while passing through the radome.

5. The error correction method of claim 4, wherein the radome angle table is a table regarding at least one of an azimuth angle and an elevation angle of a beam.

6. The error correction method of claim 4, wherein the extracting of the first measured angle corresponding to the first input angle from the radome angle table is performed when the first measured angle corresponding to the first input angle is in the radome angle table, and
the error correction method further comprises, when the first measured angle corresponding to the first input angle is not in the radome angle table:
extracting, by the processor, an input angle closest to the first input angle from the radome angle table;
extracting, by the processor, a measured angle corresponding to the closest input angle from the radome angle table; and
determining, by the processor, the first measured angle based on the closest measured angle.

7. The error correction method of claim 6, wherein the closest input angle comprises an upper input angle and a lower input angle that is closest to the first input angle,
the closest measured angle comprises an upper measured angle corresponding to the upper input angle and a lower measured angle corresponding to the lower input angle, and
the first measured angle is an angle obtained by interpolating the first input angle, the upper input angle, the lower input angle, the upper measured angle, and the lower measured angle.

8. The error correction method of claim 1, wherein the input angle, the measured angle, and the correction angle comprise at least one of an azimuth angle and an elevation angle of a beam.

9. The error correction method of claim 1, wherein the processor is configured to perform the receiving of the user input through the determining of the correction angle for each of a plurality of frequencies.

10. The error correction method of claim 9, wherein the processor is further configured to determine, as the correction angle, a sum of a plurality of correction angles respectively determined for the plurality of frequencies.

11. The error correction method of claim 1, wherein the first error is calculated from an absolute value of a difference between the first input angle and the first measured angle.

12. A computer-readable recording medium having recorded thereon a program for executing the error correction method for the active electronically scanned array (AESA) radar system according to claim 1 on a computing device.

13. A computer program stored in a medium to execute the error correction method for the active electronically scanned array (AESA) radar system according to claim 1 on a computing device.
